(19) United States
(12) Patent Application Publication
(10) Pub. No.: US 2020/0409218 A1
(43) Pub. Date: Dec. 31, 2020

(54) DIFFUSION SHEET, BACKLIGHT UNIT, LIQUID CRYSTAL DISPLAY DEVICE, AND INFORMATION EQUIPMENT

(71) Applicant: KEIWA Inc., Tokyo (JP)

(72) Inventors: Chengheng TSAI, Taipei City (TW); Yuki MATSUNO, Tokyo (JP); Hitomi SHIINA, Tokyo (JP); Taihei SUZUKI, Tokyo (JP)

(21) Appl. No.: 16/884,778

(22) Filed: May 27, 2020

(30) Foreign Application Priority Data
Jun. 25, 2019 (JP) 2019-116975

(51) Int. Cl. G02F 1/13357; G06K 9/00

(52) U.S. Cl. CPC G02F 1/133606; G06K 9/00046

(57) ABSTRACT

A diffusion sheet used in a liquid crystal display device in which when a finger pulp is put on a designated spot of a liquid crystal display panel, information obtained based on a fingerprint on the finger pulp is read using an infrared light source. The diffusion sheet has a haze value of 60% or more with respect to visible light, and has a haze value of 75% or less with respect to infrared light.

### CROSS-REFERENCE TO RELATED APPLICATION

This application claims priority to and the benefit of Japanese Patent Application No. 2019-116975, filed on Jun. 25, 2019, the entire disclosure of which as is incorporated by reference herein.

### BACKGROUND

The present disclosure relates to a diffusion sheet used in a liquid crystal display device, a backlight unit including the diffusion sheet, a liquid crystal display device including the backlight unit, and information equipment including the liquid crystal display device. In recent years, an increasing number of various types of information equipment such as smartphones and tablet terminals include fingerprint recognition systems for personal identification utilizing fingerprints to improve the security. There are various types of fingerprint recognition systems, among which optical systems using near-infrared light are relatively inexpensive.

Optical fingerprint recognition systems employ a light-emitting diode (LED) as a light source irradiating a recognition target with light, and an image sensor for reading reflected light from a fingerprint surface.

Information equipment equipped with a fingerprint recognition system has included a display screen and a fingerprint recognition generally separated from each other. However, with an increase in the sizes of display screens, smartphones employing an organic electroluminescent (EL) display include a fingerprint recognition area within the display screen.

### BRIEF SUMMARY

At present, there is the following technical demand in information equipment employing a liquid crystal display device, for example, a smartphone employing a liquid crystal display panel. In such the information equipment, it is desired that when a finger pulp is placed on a designated spot of the liquid crystal display panel, fingerprint information on this finger pulp can be read. If the read fingerprint information is identical with fingerprint information registered in advance (or falls within a certain error range), the smartphone is unlocked.

More specifically, the following is considered in a smartphone employing such a liquid crystal display panel. An infrared light source is located below the liquid crystal display panel and a diffusion sheet to irradiate a finger pulp on the liquid crystal display panel. The information on the reflected light from the finger pulp is detected by an infrared detector, thereby reading the fingerprint information.

A typical liquid crystal display device (see, e.g., Japanese Patent No. 3119846) employs a diffusion sheet containing resin beads with a particle size ranging from about 1 μm to about 50 μm in a matrix resin (i.e., a resin binder) to uniformly diffuse light, within the visible spectrum, emitted from a light source. It is however found that this diffusion sheet hinders detection of the fingerprint information using the infrared light. Since a liquid crystal display device needs to secure uniform light within the visible spectrum, a diffusion sheet is a necessary member for the liquid crystal display device. For this reason, a liquid crystal display device employing a typical diffusion sheet fails to perform fingerprint recognition on a liquid crystal panel.

In such circumstances, as competition with information equipment employing an organic EL display with an established fingerprint recognition technique on the display, there is a technical objective to achieve fingerprint recognition on a liquid crystal panel in information equipment employing a liquid crystal display device.

It is thus an objective of the present disclosure to provide a diffusion sheet for a liquid crystal display device capable of fingerprint recognition on a liquid crystal display panel.

In order to achieve the objective, the present inventors have studied the reason why a typical liquid crystal display device fails to perform fingerprint recognition on the liquid crystal display panel using infrared light and found the following. Specifically, a typical diffusion sheet diffuses light within the visible spectrum well but also diffuses light within the infrared spectrum. It is found that the diffusion of the light within the infrared spectrum is the cause for hindering the fingerprint recognition on the liquid crystal display panel using the infrared light. There is thus a need for an unprecedented approach in designing a diffusion sheet to achieve the objective of the present disclosure. As a result of further intensive studies, the present inventors found the following. In order to solve the problem of the typical diffusion sheet, an optical design needs to be applied to the diffusion sheet to diffuse light within the visible spectrum well and reduce diffusion of light within the infrared spectrum. The present disclosure was made based on the findings described above.

The diffusion sheet according to the present disclosure is used in a liquid crystal display device in which when a finger pulp is put on a designated spot of a liquid crystal display panel, information obtained based on a fingerprint on the finger pulp is read using an infrared light source. The diffusion sheet has a haze value of 60% or more with respect to visible light. The diffusion sheet has a haze value of 75% or less with respect to infrared light.

The diffusion sheet according the present disclosure has the haze value of 60% or more with respect to the visible light to maintain the diffusion properties of the visible light. The diffusion sheet has the haze value of 75% or less with respect to the infrared light to reduce the diffusion properties of the infrared light without hindering the advantages (e.g., the uniform diffusion of the visible light) of the typical diffusion sheet. In this state, the fingerprint information on the finger pulp placed on the liquid crystal display panel is read. As described above, the obtained sheet meets the demand for two contradictory characteristics, excellent diffusion of light within the visible spectrum and reduced diffusion of light within the infrared spectrum.

Note that the haze value with respect to the visible light may be, for example, the haze value at or near the peak wavelength of the light source included in the backlight unit of the liquid crystal display device within the visible spectrum. The haze value with respect to the infrared light may be, for example, the haze value at or near the peak wavelength of the infrared light source for fingerprint recognition.

The diffusion sheet according the present disclosure may include a matrix resin; and particles contained in the matrix resin and made of at least one of an organic or inorganic substance.

In this configuration, the particles contained in the matrix resin allow uniform diffusion of the visible light. In this case, the matrix resin being an acrylic resin or a polycarbonate resin and the particles made of titanium oxide easily adjust the haze values with respect to the visible and infrared light. In particular, the particles with an average size of ½ or less of the peak wavelength of the infrared light source reliably reduces the haze value with respect to the infrared light.

In the diffusion sheet according to the present disclosure, the peak wavelength of the infrared light source may fall within a near-infrared spectrum.

This configuration allows fingerprint recognition at low costs.

A backlight unit according to the present disclosure is included in a liquid crystal display device in which when a finger pulp is put on a designated spot of a liquid crystal display panel, information obtained based on a fingerprint on the finger pulp is read using an infrared light source, and guides light emitted from a light source with a peak wavelength within a visible spectrum to a display surface of the liquid crystal display device. The backlight unit includes the diffusion sheet according to the present disclosure.

Including the diffusion sheet according to the present disclosure, the backlight unit according to the present disclosure provides at least the same advantages as the diffusion sheet.

The liquid crystal display device according to the present disclosure includes the backlight unit according to the present disclosure and a liquid crystal display panel.

Including the backlight unit according to the present disclosure, the liquid crystal display device according to the present disclosure provides at least the same advantages as the diffusion sheet according to the present disclosure.

Information equipment includes the liquid crystal display device according to the present disclosure.

Including the liquid crystal display device unit according to the present disclosure, the information equipment according to the present disclosure provides at least the same advantages as the diffusion sheet according to the present disclosure.

The present disclosure provides a diffusion sheet suitably used in a liquid crystal display device in which when a finger pulp is put on a designated spot of a liquid crystal display panel, information obtained based on a fingerprint on the finger pulp is read using an infrared light source. The diffusion sheet provides a backlight unit suitably used in the liquid crystal display device, a liquid crystal display device including the backlight unit, and information equipment including the liquid crystal display device.

### BRIEF DESCRIPTION OF THE DRAWINGS

FIG. 1 is a cross-sectional view of a liquid crystal display device according to an embodiment.

FIG. 2 shows a principle of fingerprint recognition performed by the liquid crystal display device shown in FIG. 1.

FIG. 3 is a cross-sectional view of a backlight unit constituting the liquid crystal display device shown in FIG. 1.

FIG. 4 is a cross-sectional view of an example of the diffusion sheet constituting the backlight unit shown in FIG. 3.

FIG. 5 is a cross-sectional view of another example of the diffusion sheet constituting the backlight unit shown in FIG. 3.

FIG. 6 shows the configurations of diffusion sheets according to Examples 1 to 4 and Comparative Examples 1 to 3, and the haze values and visibilities of the diffusion sheets with respect to visible and infrared light.

FIG. 7 shows the configurations of diffusion sheets according to Examples 5 to 8 and Comparative Examples 4 to 7, and the haze values and visibilities of the diffusion sheets with respect to visible and infrared light.

FIG. 8 is a test chart used to evaluate the visibilities of the diffusion sheets according to Examples 1 to 8 and Comparative Examples 1 to 7 with respect to visible and infrared light.

FIG. 9 shows the visibilities of the diffusion sheets according to Examples 1 to 4 and Comparative Examples 1 to 3 with respect to visible and infrared light.

FIG. 10 shows the visibilities of the diffusion sheets according to Examples 5 to 8 and Comparative Examples 4 to 7 with respect to visible and infrared light.

FIG. 11 shows the relationship between the haze values and visibilities of the diffusion sheets according to Examples 1 to 8 and Comparative Examples 1 to 7 with respect to infrared light.

FIG. 12 shows the relationship between the haze values and visibilities of the diffusion sheets according to Examples 1 to 8 and Comparative Examples 1 to 7 with respect to visible light.

### DETAILED DESCRIPTION OF VARIOUS EMBODIMENTS

Now, an exemplary embodiment of the present disclosure is described with reference to the drawings. The scope of the present disclosure is not limited to the following embodiment. Any modification may be made within the spirit and scope of the present disclosure.

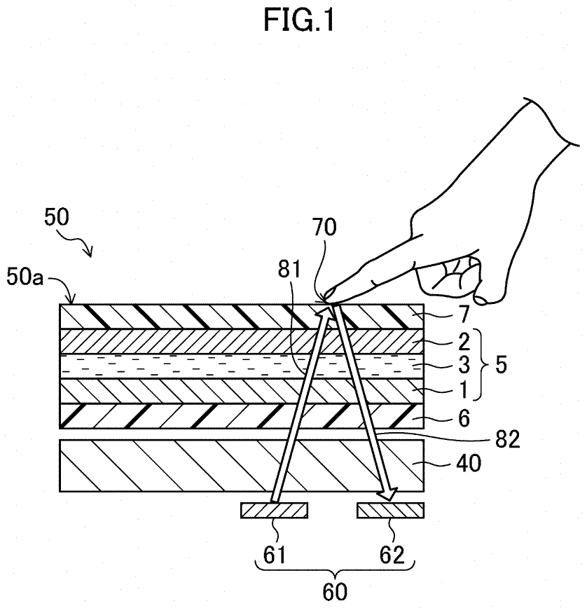

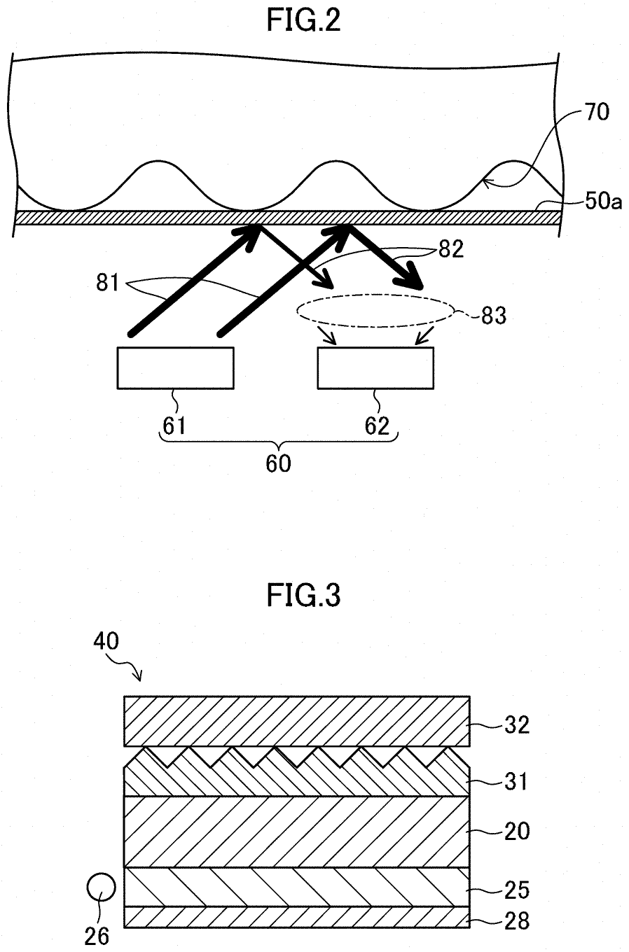

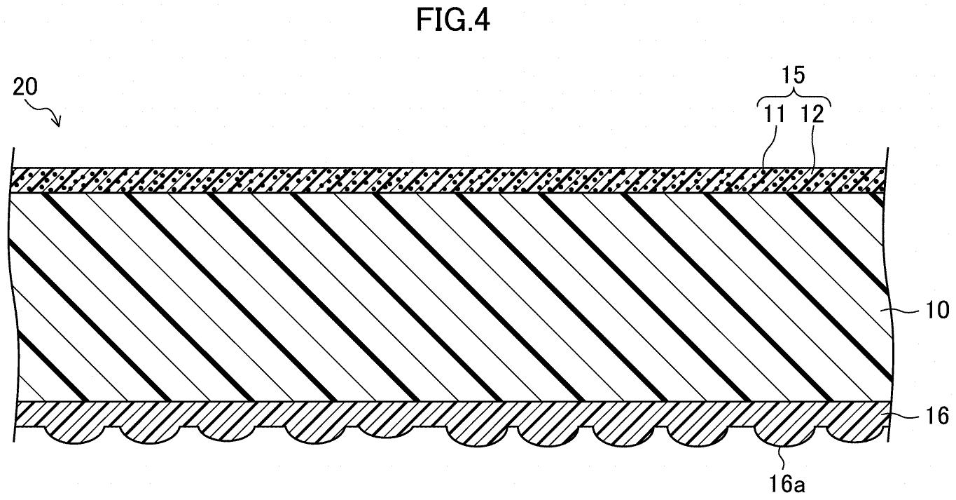

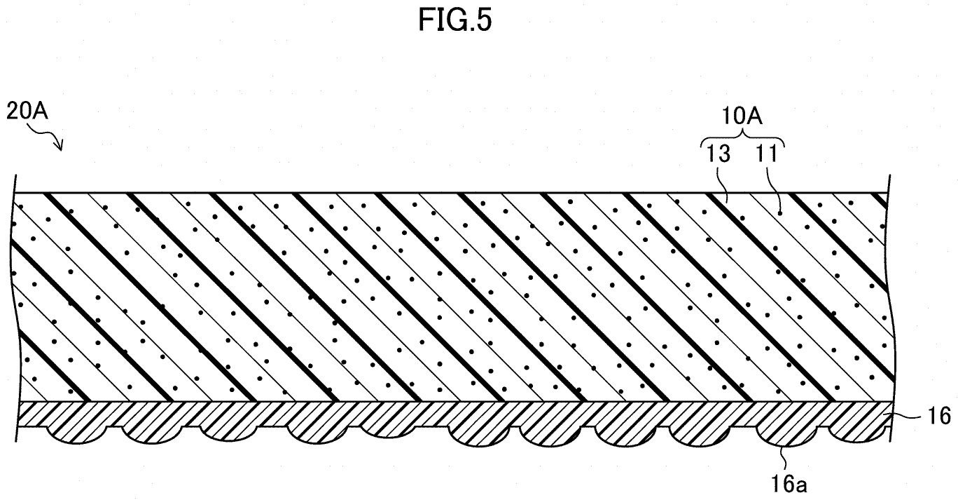

FIGS. 1 to 5 show a diffusion sheet, a backlight unit, and a liquid crystal display device according to the embodiment of the present disclosure. FIG. 1 is a cross-sectional view of a liquid crystal display device 50 according to this embodiment. FIG. 2 shows a principle of fingerprint recognition performed by the liquid crystal display device 50. FIG. 3 is a cross-sectional view of an example of the backlight unit 40 constituting the liquid crystal display device 50. FIG. 4 is a cross-sectional view of an example of the diffusion sheet 20 constituting the backlight unit 40. FIG. 5 is a cross-sectional view of a diffusion sheet 20A that is a variation of the diffusion sheet 20.

As shown in FIG. 1, the liquid crystal display device 50 includes a liquid crystal display panel 5, a first polarizer 6, a second polarizer 7, the backlight unit 40, and a fingerprint recognition device 60. The first polarizer 6 is attached to the lower surface of the liquid crystal display panel 5 in the figure. The second polarizer 7 is attached to the upper surface of the liquid crystal display panel 5 in the figure. The backlight unit 40 is located at the back side (i.e., the lower side in the figure) of the liquid crystal display panel 5 with the first polarizer 6 interposed therebetween. The fingerprint recognition device 60 is located at the back side (i.e., the lower side in the figure) of the backlight unit 40.

As shown in FIG. 1, the liquid crystal display panel 5 includes a thin-film transistor (TFT) substrate 1, a color filter (CF) substrate 2, a liquid crystal layer 3, and a sealing member (not shown). The TFT substrate 1 faces the CF substrate 2. The liquid crystal layer 3 is interposed between the TFT substrate 1 and the CF substrate 2. The sealing member is formed in a frame shape to enclose the liquid crystal layer 3 between the TFT substrate 1 and the CF substrate 2.

The TFT substrate 1 includes, for example, TFTs, an interlayer insulating film, pixel electrodes, and an alignment film. The TFTs are arranged in a matrix on a glass substrate. The interlayer insulating film covers the TFTs. The pixel electrodes are arranged in a matrix on the interlayer insulating film. Each pixel electrode is connected to one of the TFTs. The alignment film covers the pixel electrodes. Each of the TFTs is here, for example, electrically connected to associated one of gate lines extending in parallel to each other on the glass substrate. In addition, each of the TFTs is, for example, electrically connected to associated one of source lines extending in parallel to each other and orthogonal to the gate lines on a gate insulating film covering the gate lines.

The CF substrate 2 includes, for example, a black matrix, a color filter, a common electrode, and an alignment film. The black matrix is a lattice on a glass substrate. The color filter includes red, green, and blue layers, each of which is located in one of meshes of the black matrix. The common electrode covers the black matrix and the color filter. The alignment film covers the common electrode.

The liquid crystal layer 3 is made of a nematic liquid crystal material, for example, containing liquid crystal molecules with electrooptic properties.

Each of the first polarizer 6 and the second polarizer 7 includes, for example, a polarizer layer with a polarization axis extending in one direction and a pair of protective layers to sandwich the polarizer layer. The polarizer layer is here, for example, a polyvinyl alcohol film that is obtained such that the polyvinyl alcohol film adsorbs iodine and is stretched, for example. Each of the protective layers is made of a triacetyl cellulose (TAC) film, for example.

The fingerprint recognition device 60 includes an infrared light source 61 and an infrared detector 62. The infrared light source 61 irradiates a recognition target with light. The infrared detector 62 receives reflected light from the recognition target. The infrared light source 61 may be, for example, a near-infrared light source with a constant wavelength distribution (broadening) within a range from 750 nm to 950 nm and a peak wavelength of 850 nm. Alternatively, the light source may be a near-infrared light source with a constant wavelength distribution (broadening) within a range of 850 nm to 1050 nm and a wavelength peak of 940 nm. The mid-infrared light and the far-infrared light have higher absorbances of water. As a result, most of the mid- and far-infrared light is absorbed in a shallower region of a biological tissue. A peak wavelength of the infrared light source 61 within the near-infrared spectrum provides a sufficient amount of reflected light required for fingerprint recognition. The infrared detector 62 may be an image sensor of a charge-coupled device (CCD) type or a complementary metal-oxide-semiconductor (CMOS) type, for example.

In the fingerprint recognition system 60, as shown in FIGS. 1 and 2, once a person's finger (i.e. finger pulp) 70 touches a designated spot of the liquid crystal display panel 5 (specifically, a display surface 50a of the liquid crystal display device 50), irradiation light 81 from the light source 61 is reflected by the display surface 50a touched by the finger 70. Reflected light 82 is received by the infrared detector 62. At this time, total reflection occurs at the concaves of the fingerprint of the finger 70 so that the amount of the reflected light 82 is almost equal to that of the irradiation light 81. On the other hand, irregular reflection occurs at the convexes of the fingerprint of the finger 70 so that the amount of the reflected light 82 is smaller than that of the irradiation light 81. In this manner, the reflected light 82 received by the infrared detector 62 produces a shadow 83 corresponding to the fingerprint shape of the finger 70. The fingerprint recognition system 60 records this shadow 83 using a processing circuit (not shown) and performs fingerprint recognition through matching of the shadow with fingerprint information registered in advance.

As described above, in the liquid crystal display device 50 shown in FIG. 1, when a finger pulp is put on a designated spot of a liquid crystal display panel 5, information obtained based on a fingerprint on the finger pulp is read using an infrared light source 61. The liquid crystal display device 50 may be mounted on any type of information equipment such as a smartphone or a tablet terminal, which allows fingerprint recognition on the display screen to, for example, lock and unlock the equipment.

As shown in FIG. 3, the backlight unit 40 includes the diffusion sheet 20, a first prism sheet 31, a second prism sheet 32, a light guide plate 25, a light source 26, and a reflective sheet 28. The first prism sheet 31 and the second prism sheet 32 are arranged in this order on the diffusion sheet 20 in the figure. The light guide plate 25 is located under the diffusion sheet 20 in the figure. The light source 26 is located at a side of the light guide plate 25. The reflective sheet 28 is located under the light guide plate 25 in the figure.

As shown in FIG. 4, the diffusion sheet 20 includes a resin base layer 10, a light diffusion layer 15, and a rear surface resin layer 16. The light diffusion layer 15 is located on the upper surface of the resin base layer 10 in the figure. The rear surface resin layer 16 is located on the lower surface of the resin base layer 10 in the figure. The diffusion sheet 20 shown in FIG. 4 includes a plurality of layers corresponding to the functions required to the diffusion sheet 20. Specifically, the resin base layer 10 functions, as a base film, to provide a higher rigidity, transparency, or other characteristics of the diffusion sheet 20. The light diffusion layer 15 functions to reduce the diffusion properties of light within the infrared spectrum while ensuring higher diffusion properties of light within the visible spectrum, which is required in the present disclosure. The rear surface resin layer 16 functions to reduce sticking between the diffusion sheet 20 and another member stacked within the backlight unit 40 or scratching of the diffusion sheet 20. In this embodiment, the diffusion sheet 20 is the multilayer described above. Needless to mention, the diffusion sheet may be a single layer.

The resin base layer 10 is, for example, a light-transmissive transparent, translucent, or milky white film with a thickness ranging from about 20 μm to about 50 μm. Examples of the material include a polyethylene terephthalate resin, a polyethylene naphthalate resin, an acrylic resin, a polycarbonate resin, a polystyrene resin, a polyolefin resin, a cellulose acetate resin, and a light-resistant polyvinyl chloride resin.

The light diffusion layer 15 has, for example, a thickness ranging from about 5μm to about 15 μm and includes particles 11 and a matrix resin (i.e., a binder resin) 12 as shown in FIG. 4. The particle 11 are made of at least one of an organic or inorganic substance. The particles 11 are fixed to the surface of the resin base layer 10 by the matrix resin 12. The contents of the particles 11 range, for example, from about 5 mass % to about 250 mass % of the matrix resin 12. The light diffusion layer 15 has a mass ranging, for example, from about 6.0 g/m² to about 7.0 g/m² per unit area. In order to reduce the adhesion to the first prism sheet 31, the light diffusion layer 15 may contain resin beads to the extent not hindering the diffusion properties of the visible light. The resin beads are fine organic particles with an average particle size ranging from about 3 μm to about 12 μm. Examples of the material include an acrylic resin, an acrylonitrile resin, a polyurethane resin, a polyvinyl chloride resin, a polystyrene resin, and a polyamide resin.

The particles 11 are made of titanium oxide, zirconium oxide, alumina, or silica, zinc oxide, for example, and has an average particle size ranging, for example, from about 0.02 μm to about 0.5μm. The particles 11 may be the primary particles individually dispersed in the matrix resin 12, or may be secondary particles aggregated from the primary particles and individually dispersed in the matrix resin 12. The average particle size is calculated as follows. First, the cross section of a measurement sample is formed using a microtome or any other instrument and observed and analyzed using a scanning electron microscope to specify a particle region. Next, the particle size of the region specified as the particle region is calculated from an image, which is repeated for 50 regions to obtain the average of the 50 particle sizes as the average particle size.

Examples of the matrix resin 12 include an acrylic resin, a polycarbonate resin, an epoxy resin, a silicone resin, a phenol resin, a urea resin, an unsaturated polyester resin, a melamine resin, an alkyd resin, a polyimide resin, an amide functional copolymer resin, a urethane resin, a methyl methacrylate styrene copolymer resin, a polystyrene resin, and a polyethylene terephthalate resin.

The rear surface resin layer 16 has a thickness ranging from about 3μm to about 15 μm, for example. Examples of the material include an acrylic resin, an epoxy resin, a silicone resin, a phenol resin, a urea resin, an unsaturated polyester resin, a melamine resin, an alkyd resin, a polyimide resin, an amide functional copolymer resin, and a urethane resin. As shown in FIG. 4, the rear surface resin layer 16 has an uneven surface 16a to reduce or completely hinder the adhesion to the surface of the light guide plate 25.

Each of the first prism sheet 31 and the second prism sheet 32 is, for example, an acrylic resin film with a transverse section with isosceles triangle chamfers adjacent to each other. The prism formed by each adjacent pair of the chamfers has an apex of about 90°. Here, the chamfers in the first prism sheet 31 are orthogonal to the chamfers in the second prism sheet 32. While FIG. 3 illustrates the multilayer configuration of the first prism sheet 31 and the second prism sheet 32 that are independent from each other, the first prism sheet 31 and the second prism sheet 32 may be formed integrally.

The light guide plate 25 is in the shape of a rectangular plate and made of, for example, a transparent resin such as an acrylic resin or a polycarbonate resin. Here, printed on the surface of the light guide plate 25 at the reflective sheet 28 is a white dot pattern allowing the entire surface to uniformly emit light.

The light sources 26 includes, for example, a plurality of light emitting diodes (LEDs) serving as point-like light sources and aligned along a shorter side surface of the light guide plate 25. The light source 26 has a peak wavelength within the visible spectrum.

The reflective sheet 28 is a film made of a white polyethylene terephthalate resin or a silver vapor deposition film, for example. In the locations of the infrared light source 61 and the infrared detector 62 constituting the fingerprint recognition device 60, the reflective sheet 28 may be partially cut out.

The liquid crystal display device 50 described above applies a predetermined level of a voltage to the liquid crystal layer 3 in the sub-pixels, each of which corresponds to one of the pixel electrodes, and changes the alignment of the liquid crystal layer 3 to adjust the light transmittance of the light incident from the backlight unit 40 via the first polarizer 6. After that, the adjusted light is emitted via the second polarizer 7, thereby displaying an image.

In the backlight unit 40, the diffusion sheet 20 shown in FIG. 4 may be replaced with a diffusion sheet 20A shown in FIG. 5. The diffusion sheet 20A includes a resin base layer 10A and a rear surface resin layer 16 on the lower surface of the resin base layer 10A in the figure. The rear surface resin layer 16 of the diffusion sheet 20A is the same as the rear surface resin layer 16 of the diffusion sheet 20. The diffusion sheet 20A may also include a layer for hindering the adhesion to the first prism sheet 31 on the upper surface of the resin base layer 10A in the figure. The rear surface resin layer 16 may be integral with the resin base layer 10A.

The resin base layer 10A has, for example, a thickness ranging from about 30 μm to about 500 μm, and includes a matrix resin 13 and particles 11 as shown in FIG. 5. The particles 11 are contained in the matrix resin 13 and made of at least one of an organic or inorganic substance. The contents of the particles 11 range, for example, from about 0.01 mass % to about 20 mass % of the matrix resin 13. The particles 11 of the resin base layer 10A are the same as the particles 11 of the resin base layer 10 of the diffusion sheet 20.

Examples of the matrix resin 13 include an acrylic resin, a polycarbonate resin, an epoxy resin, a silicone resin, a phenol resin, a urea resin, an unsaturated polyester resin, a melamine resin, an alkyd resin, a polyimide resin, an amide functional copolymer resin, a urethane resin, a methyl methacrylate styrene copolymer resin, a polystyrene resin, and a polyethylene terephthalate resin.

In this embodiment, the diffusion sheet 20 or 20A constituting the backlight unit 40 has haze values of 60% or more with respect to visible light, and 75% or less with respect to infrared light. Here, the haze value is an index indicating specific optical properties related to the wide-angle scattering of light. A greater haze value indicates higher diffusion properties, whereas a smaller haze value indicates lower diffusion properties. Specifically, the haze value is determined as follows. With the use of an ultraviolet (UV)-visible spectrophotometer (specifically, SolidSpec-3700 manufactured by Shimadzu Corporation), the total transmitted light and the diffused light with a wavelength ranging from 380 nm to 1200 nm is measured. The haze value determination is carried out once with the visible light having a wavelength of 550 nm and once with the infrared light having a wavelength of 850 nm, each based on the equation “Diffused Light/Total Transmitted Light×100=Haze Value”.

Note that the haze value with respect to the visible light may be, for example, the haze value at or near the peak wavelength of the light source 26 included in the backlight unit 40 of the liquid crystal display device 50, with the peak wavelength being within the visible spectrum. The haze value with respect to the infrared light may be, for example, the haze value at or near the peak wavelength of the infrared light source 61 for fingerprint recognition.

The diffusion sheet 20 or 20A according this embodiment described above has a haze value of 60% or more with respect to the visible light to maintain the diffusion properties of the visible light. The diffusion sheet has a haze value of 75% or less with respect to infrared light to reduce the diffusion properties of the infrared light without hindering the advantages (e.g., the uniform diffusion of the visible light) of the typical diffusion sheet. In this state, the fingerprint information on the finger pulp placed on the liquid crystal display panel 5 is read.

The diffusion sheet 20 or 20A according this embodiment includes a matrix resin 12 or 13 and particles 11 contained in the matrix resin 12 or 13 and made of at least one of an organic or inorganic substance. In this configuration, the particles contained in the matrix resin 12 or 13 allow uniform diffusion of the visible light. In this case, the matrix resin 12 or 13 being an acrylic resin or a polycarbonate resin and the particles 11 made of titanium oxide easily adjust the haze values with respect to the visible and infrared light. In particular, the particles 11 with an average size of ½ or less of the peak wavelength of the infrared light source 61 reliably reduces the haze value with respect to the infrared light.

The diffusion sheet 20 or 20A according to this embodiment provides the backlight unit 40 suitably used in the liquid crystal display device 50, the liquid crystal display device 50 including the backlight unit 40, and information equipment including the liquid crystal display device 50.

The liquid crystal display device 50 according to this embodiment performs fingerprint recognition at low costs, if the infrared light source has a peak wavelength within the near-infrared light spectrum.

### EXAMPLES AND COMPARATIVE EXAMPLES

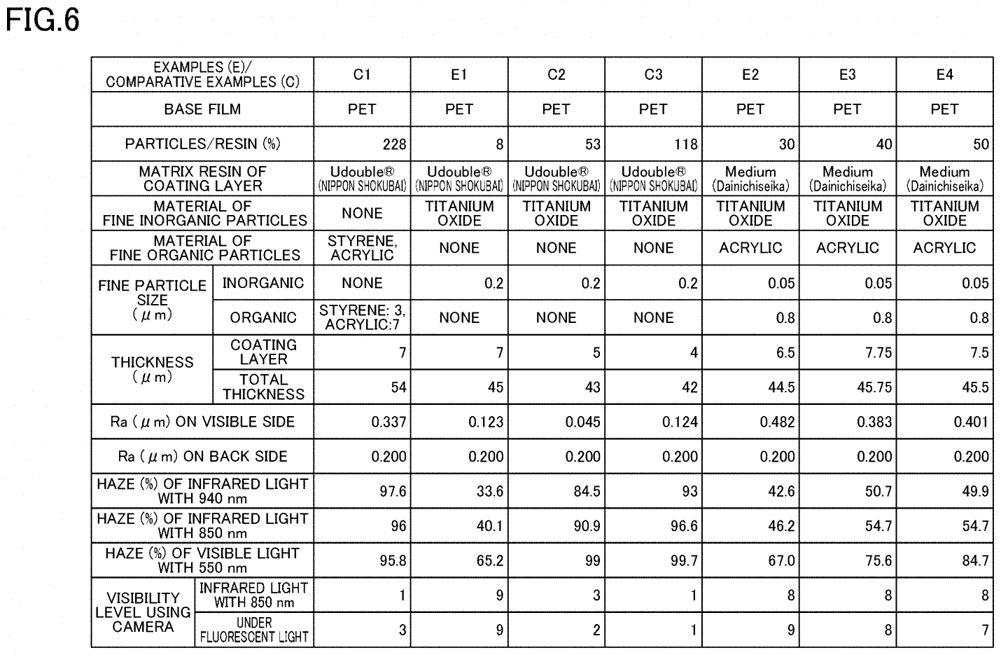

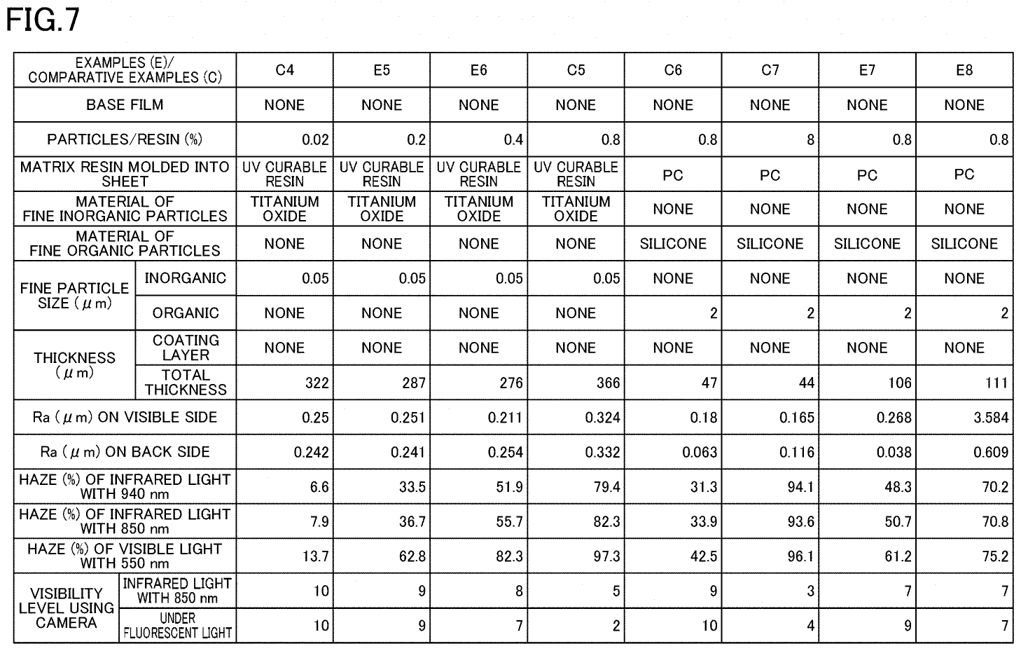

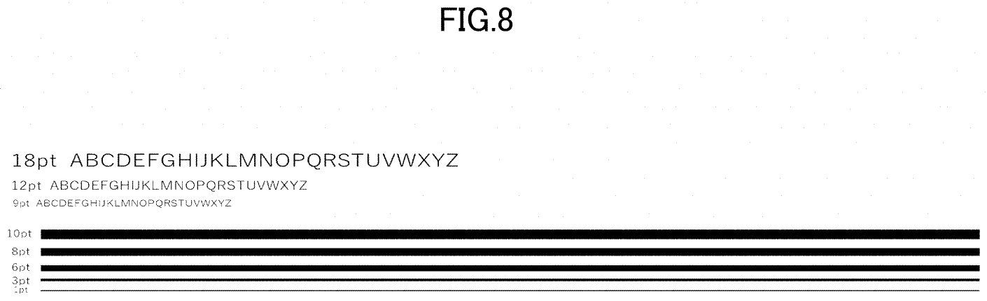

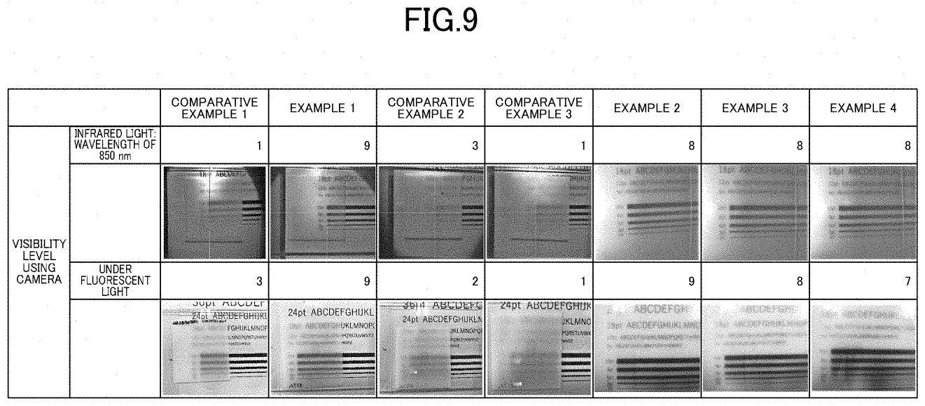

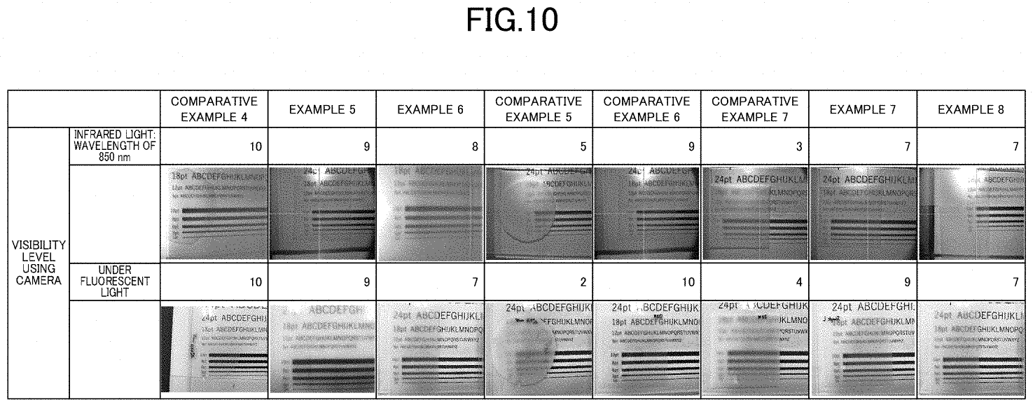

Now, examples and comparative examples will be described with reference to the drawings. FIG. 6 shows the configurations of the diffusion sheets according to Examples 1 to 4 and Comparative Examples 1 to 3, and the haze values and visibilities of the diffusion sheets with respect to visible and infrared light. FIG. 7 shows the configurations of the diffusion sheets according to Examples 5 to 8 and Comparative Examples 4 to 7, and the haze values and visibilities of the diffusion sheets with respect to visible and infrared light. Note that Examples 1 to 8 respectively correspond to E1 to E8 and Comparative Examples 1 to 7 respectively correspond to C1 to C7 in FIGS. 6 and 7. FIG. 8 is a test chart used to evaluate the visibilities of the diffusion sheets according to Examples 1 to 8 and Comparative Examples 1 to 7 with respect to visible and infrared light. FIG. 9 shows the visibilities of the diffusion sheets according to Examples 1 to 4 and Comparative Examples 1 to 3 with respect to visible and infrared light. FIG. 10 shows the visibilities of the diffusion sheets according to Examples 5 to 8 and Comparative Examples 4 to 7 with respect to visible and infrared light.

The haze values of the diffusion sheets according to the examples and the comparative examples with respect to the infrared and visible light were calculated as follows. Specifically, the haze values were calculated as follows. With the use of an ultraviolet (UV) visible spectrophotometer (specifically, SolidSpec-3700 manufactured by Shimadzu Corporation), the total transmitted light and the diffused light with a wavelength ranging from 380 nm to 1200 nm is measured. The haze value determination was carried out once with the visible light having a wavelength of 550 nm, once with the infrared light having a wavelength of 850 nm and once with the infrared light having a wavelength of 940 nm, each based on the equation “Diffused Light/Total Transmitted Light×100=Haze Value”.

The visibilities of the diffusion sheets according to the examples and the comparative examples with respect to the infrared and visible light were evaluated as follows. Each diffusion sheet was placed on the test chart shown in FIG. 8. The blur of the characters was observed from above through the diffusion sheet. Used as the test chart shown in FIG. 8 is a sheet of paper, on which the alphabet in the font sizes of 18 pt, 12 pt, and 9 pt (in Yu Gothic) and the lines with thicknesses of 10 pt, 8 pt, 6 pt, 3 pt, and 1 pt were printed in black and white. In the visibility evaluation, the test chart was spaced apart from each diffusion sheet at a distance of 2.5 mm. Each of the diffusion sheets (according to Comparative Examples 1 to 3 and Examples 1 to 4, and 8) with the front and back sides has the matte surface or the coating surface facing the test chart. In the evaluation with the visible light, a photograph of the test chart seen through each diffusion sheet was taken under a fluorescent light using a smartphone. In the evaluation with the infrared light, a photograph of the test chart seen through each diffusion sheet was taken under the infrared light with peak wavelengths of 850 nm and 940 nm in a dark room using an infrared camera (specifically, ACE-80IR manufactured by HI-LAND). Based on the taken photographs, the visibilities of the diffusion sheet were classified into ten levels from 1 to 10. In level 1, the characters in 18 pt were completely blurred and invisible, whereas level 10 represents the visibility without any diffusion sheet. In the following Examples and Comparative Examples, the cases with level 7 or higher were acceptable with respect to the infrared light, and the cases with level 9 or less were acceptable with respect to the visible light.

### Comparative Example 1

In Comparative Example 1, OPALUS (registered trademark) UDD-247D2manufactured by KEIWA Inc. was used as the diffusion sheet. Specifically, as shown in FIG. 6, the diffusion sheet according to Comparative Example 1 has a total thickness of 54 μm and includes a coating layer on a base film. The base film is made of polyethylene terephthalate (hereinafter, referred to as PET). The coating layer has a thickness of 7 μm and is made of a matrix resin (specifically, Udouble (registered trademark) manufactured by NIPPON SHOKUBAI CO., LTD.) that is an acrylic resin containing styrene and acrylic (as fine organic particles). Here, the mass ratio of the fine particles to the matrix resin is 228%. The styrene (as primary particles) has an average particle size of 3 μm, whereas the acrylic (as primary particles) has an average particle size of 7 μm.

The diffusion sheet according to Comparative Example 1 was produced by the following method. First, the fine organic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Comparative Example 1 has roughnesses (Ra) of 0.337 μm and 0.200 μm on the visible side (i.e., at the liquid crystal display panel 5) and the back side (i.e., at the fingerprint recognition device 60), respectively.

Further, as shown in FIG. 6, the diffusion sheet according to Comparative Example 1 has haze values of 97.6%, 96%, and 95.8% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Comparative Example 1 has visibility levels 1 and 3 when using the camera under the infrared light with the wavelength of 850 nm and the camera under the visible light (i.e., the fluorescent light), respectively.

As described above, the diffusion sheet according to Comparative Example 1 has excellent diffusion properties of the visible light but higher haze values with respect to the infrared light, that is, fails to reduce the diffusion properties of the infrared light. It is thus difficult to apply the diffusion sheet to fingerprint recognition.

### Example 1

As shown in FIG. 6, the diffusion sheet according to Example 1 has a total thickness of 45 μm and includes a coating layer on a base film. The base film is made of PET. The coating layer has a thickness of 7 μm and is made of a matrix resin (specifically, Udouble (registered trademark) manufactured by NIPPON SHOKUBAI CO., LTD.) that is an acrylic resin containing titanium oxide (as fine inorganic particles). Here, the mass ratio of the fine particles to the matrix resin is 8%. The titanium oxide (as primary particles) has an average particle size of 0.2 μm (i.e., 200 nm). That is, the average particle size of the titanium oxide is ½ or less of the peak wavelengths of 850 nm and 940 nm of the infrared light source.

The diffusion sheet according to Example 1 was produced by the following method. First, the fine inorganic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Example 1 has roughnesses (Ra) of 0.123 μm and 0.200 μm on the visible side (i.e., at the liquid crystal display panel 5) and the back side (i.e., at the fingerprint recognition device 60), respectively.

Further, as shown in FIG. 6, the diffusion sheet according to Example 1 has haze values of 33.6%, 40.1%, and 65.2% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Example 1 has visibility levels 9 and 9 when using the camera under the infrared light with the wavelength of 850 nm and the camera under the visible light (i.e., the fluorescent light), respectively.

As described above, the diffusion sheet according to Example 1 maintains certain diffusion properties of the visible light and has lower haze values with respect to the infrared light, that is, reduced diffusion properties of the infrared light. The diffusion sheet is thus applicable to fingerprint recognition.

### Comparative Example 2

As shown in FIG. 6, the diffusion sheet according to Comparative Example 2 has a total thickness of 43 μm and includes a coating layer on a base film. The base film is made of PET. The coating layer has a thickness of 5 μm and is made of a matrix resin (specifically, Udouble (registered trademark) manufactured by NIPPON SHOKUBAI CO., LTD.) that is an acrylic resin containing titanium oxide (as fine inorganic particles). Here, the mass ratio of the fine particles to the matrix resin is 53%. The titanium oxide (as primary particles) has an average particle size of 0.2 μm.

The diffusion sheet according to Comparative Example 2 was produced by the following method. First, the fine inorganic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Comparative Example 2 has roughnesses (Ra) of 0.045 μm and 0.200 μm on the visible side (i.e., at the liquid crystal display panel 5) and the back side (i.e., at the fingerprint recognition device 60), respectively.

Further, as shown in FIG. 6, the diffusion sheet according to Comparative Example 2 has haze values of 84.5%, 90.9%, 99% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Comparative Example 2 has visibility levels 3 and 2 when using the camera under the infrared light with the wavelength of 850 nm and the camera under the visible light (i.e., the fluorescent light), respectively.

As described above, the diffusion sheet according to Comparative Example 2 has excellent diffusion properties of the visible light but higher haze values with respect to the infrared light, that is, fails to reduce the diffusion properties of the infrared light. It is thus difficult to apply the diffusion sheet to fingerprint recognition.

### Comparative Example 3

As shown in FIG. 6, the diffusion sheet according to Comparative Example 3 has a total thickness of 42 μm and includes a coating layer on a base film. The base film is made of PET. The coating layer has a thickness of 4 μm and is made of a matrix resin (specifically, Udouble (registered trademark) manufactured by NIPPON SHOKUBAI CO., LTD.) that is an acrylic resin containing titanium oxide (as fine inorganic particles). Here, the mass ratio of the fine particles to the matrix resin is 118%. The titanium oxide (as primary particles) has an average particle size of 0.2 μm.

The diffusion sheet according to Comparative Example 3 was produced by the following method. First, the fine inorganic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Comparative Example 3 has roughnesses (Ra) of 0.124 μm and 0.200 μm on the visible side (i.e., at the liquid crystal display panel 5) and the back side (i.e., at the fingerprint recognition device 60), respectively.

Further, as shown in FIG. 6, the diffusion sheet according to Comparative Example 3 has haze values of 93%, 96.6%, and 99.7% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Comparative Example 3 has visibility levels 1 and 1 when using the camera under the infrared light with the wavelength of 850 nm and the camera under the visible light (i.e., the fluorescent light), respectively.

As described above, the diffusion sheet according to Comparative Example 3 has excellent diffusion properties of the visible light but higher haze values with respect to the infrared light, that is, fails to reduce the diffusion properties of the infrared light. It is thus difficult to apply the diffusion sheet to fingerprint recognition.

### Example 2

As shown in FIG. 6, the diffusion sheet according to Example 2 has a total thickness of 44.5 μm and includes a coating layer on a base film. The base film is made of PET. The coating layer has a thickness of 6.5 μm and is made of a matrix resin (specifically, Medium manufactured by Dainichiseika Color & Chemicals Mfg. Co., Ltd.) that is an acrylic resin containing titanium oxide (as fine inorganic particles) and acrylic (as fine organic particles). Here, the mass ratio of the fine particles to the matrix resin is 30%. The titanium oxide (as primary particles) has an average particle size of 0.05 μm (i.e., 50 nm), whereas the acrylic (as primary particles) has an average particle size of 0.8 μm. That is, the average particle size of the titanium oxide is ½ or less of the peak wavelengths of 850 nm and 940 nm of the infrared light source. Note that the titanium oxide and the acrylic were mixed at a mass ratio of 1:1.

The diffusion sheet according to Example 2 was produced by the following method. First, the fine organic and inorganic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Example 2 has roughnesses (Ra) of 0.482 μm and 0.200 μm on the visible side (i.e., at the liquid crystal display panel 5) and the back side (i.e., at the fingerprint recognition device 60), respectively.

Further, as shown in FIG. 6, the diffusion sheet according to Example 2 has haze values of 42.6%, 46.2%, and 67.0% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Example 2 has visibility levels 8 and 9 when using the camera under the infrared light with the wavelength of 850 nm and the camera under the visible light (i.e., the fluorescent light), respectively.

As described above, the diffusion sheet according to Example 2 maintains certain diffusion properties of the visible light and has lower haze values with respect to the infrared light, that is, reduced diffusion properties of the infrared light. The diffusion sheet is thus applicable to fingerprint recognition.

### Example 3

As shown in FIG. 6, the diffusion sheet according to Example 3 has a total thickness of 45.75 μm and includes a coating layer on a base film. The base film is made of PET. The coating layer has a thickness of 7.75 μm and is made of a matrix resin (specifically, Medium manufactured by Dainichiseika Color & Chemicals Mfg. Co., Ltd.) that is an acrylic resin containing titanium oxide (as fine inorganic particles) and acrylic (as fine organic particles). Here, the mass ratio of the fine particles to the matrix resin is 40%. The titanium oxide (as primary particles) has an average particle size of 0.05 μm (i.e., 50 nm), whereas the acrylic (as primary particles) has an average particle size of 0.8 μm. That is, the average particle size of the titanium oxide is ½ or less of the peak wavelengths of 850 nm and 940 nm of the infrared light source. Note that the titanium oxide and the acrylic were mixed at a mass ratio of 1:1.

The diffusion sheet according to Example 3 was produced by the following method. First, the fine organic and inorganic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Example 3 has roughnesses (Ra) of 0.383 μm and 0.200 μm on the visible side (i.e., at the liquid crystal display panel 5) and the back side (i.e., at the fingerprint recognition device 60), respectively.

Also as shown in FIG. 6, the diffusion sheet according to Example 3 has haze values of 50.7%,54.7%, and 75.6% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Example 3 has visibility levels 8 and 8 when using the camera under the infrared light with the wavelength of 850 nm and the camera under the visible light (i.e., the fluorescent light), respectively.

As described above, the diffusion sheet according to Example 3 maintains certain diffusion properties of the visible light and has lower haze values with respect to the infrared light, that is, reduced diffusion properties of the infrared light. The diffusion sheet is thus applicable to fingerprint recognition.

### Example 4

As shown in FIG. 6, the diffusion sheet according to Example 4 has a total thickness of 45.5 μm and includes a coating layer on a base film. The base film is made of PET. The coating layer has a thickness of 7.5 μm and is made of a matrix resin (specifically, Medium manufactured by Dainichiseika Color & Chemicals Mfg. Co., Ltd.) that is an acrylic resin containing titanium oxide (as fine inorganic particles) and acrylic (as fine organic particles). Here, the mass ratio of the fine particles to the matrix resin is 50%. The titanium oxide (as primary particles) has an average particle size of 0.05 μm (i.e., 50 nm), whereas the acrylic (as primary particles) has an average particle size of 0.8 μm. That is, the average particle size of the titanium oxide is ½ or less of the peak wavelengths of 850 nm and 940 nm of the infrared light source. Note that the titanium oxide and the acrylic were mixed at a mass ratio of 1:1.

The diffusion sheet according to Example 4 was produced by the following method. First, the fine organic and inorganic particles were blended into the matrix resin as the binder. At this time, a dilution solvent was also blended for adjustment of viscosity. Next, the blended material was stirred using a high-speed thin-film spin mixer FILMIX (registered trademark) 40-40 manufactured by PRIMIX Corporation and then coated on the base film. After that, the material was cured at a temperature of 80° C. into the coating layer.

As shown in FIG. 6, the diffusion sheet according to Example 4 has roughnesses (Ra) of 0.401 μm and 0.200 μm on the visible side (i.e., at the liquid crystal display panel 5) and the back side (i.e., at the fingerprint recognition device 60), respectively.

Further, as shown in FIG. 6, the diffusion sheet according to Example 4 has haze values of 49.9%, 54.7%, and 84.7% with respect to the infrared light with the wavelength of 940 nm, the infrared light with the wavelength of 850 nm, and the visible light with the wavelength of 550 nm, respectively.

As shown in FIGS. 6 and 9, the diffusion sheet according to Example 4 has visibility levels 8 and 7 when using the camera under the infrared light with the wavelength of 850 nm and the camera under the visible light (i.e., the fluorescent light), respectively.

As described above, the diffusion sheet according to Example 4 maintains certain diffusion properties of the visible light and has lower haze values with respect to the infrared light, that is, reduced diffusion properties of the infrared light. The diffusion sheet is thus applicable to fingerprint recognition.

### Comparative Example 4

As shown in FIG. 7, the diffusion sheet according to Comparative Example 4 is a base sheet having a total thickness of 322 μm and made of a matrix resin that is an ultraviolet (UV) curable resin containing titanium oxide (as fine inorganic particles). Here, the mass ratio of the fine particles to the matrix resin is 0.02%. The titanium oxide (as primary particles) has an average particle size of 0.05 μm.

The diffusion sheet according to Comparative Example 4 was produced by the following method. First, ultrafine titanium oxide particles (TTO-55(S) manufactured by ISHIHARA SANGYO KAISHA, LTD.) were mixed into the UV curable resin at the mass ratio described above to prepare a titanium oxide mixed resin liquid. The UV curable resin has the same refractive index (n=1.589) as polycarbonate with respect to visible light. The mixed resin liquid was stretched into a sheet using a gap with a height of 300 μm, which was irradiated with UV light and cured to be the base sheet.

As shown in FIG. 7, the diffusion sheet according to Comparative Example 4 has roughnesses (Ra) of 0.25 μm and 0.242 μm on the visible side (i.e., at the liquid crystal display panel 5) and the back side (i.e., at the fingerprint recognition device 60), respectively.

Further, as shown in FIG. 7, the diffusion sheet according to Comparative Example 4 has haze values of 6.6%, 7.9%, and 13.7% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Comparative Example 4 has visibility levels 10 and 10 when using the camera under the infrared light with the wavelength of 850 nm and the camera under the visible light (i.e., the fluorescent light), respectively.

As described above, the diffusion sheet according to Comparative Example 4 has bad diffusion properties of the visible light. It is thus difficult to use the diffusion sheet for a liquid crystal display device.

### Example 5

As shown in FIG. 7, the diffusion sheet according to Example 5 is a base sheet having a total thickness of 287 μm and made of a matrix resin that is a UV curable resin containing titanium oxide (as fine inorganic particles). Here, the mass ratio of the fine particles to the matrix resin is 0.2%. The titanium oxide (as primary particles) has an average particle size of 0.05 μm. That is, the average particle size of the titanium oxide is ½ or less of the peak wavelengths of 850 nm and 940 nm of the infrared light source.

The diffusion sheet according to Example 5 was produced by the following method. First, ultrafine titanium oxide particles (TTO-55(S) manufactured by ISHIHARA SANGYO KAISHA, LTD.) were mixed into the UV curable resin at the mass ratio described above to prepare a titanium oxide mixed resin liquid. The UV curable resin has the same refractive index (n=1.589) as polycarbonate with respect to visible light. The mixed resin liquid was stretched into a sheet using a gap with a height of 300 μm, which was irradiated with UV light and cured to be the base sheet.

As shown in FIG. 7, the diffusion sheet according to Example 5 has roughnesses (Ra) of 0.251 μm and 0.241 μm on the visible side (i.e., at the liquid crystal display panel 5) and the back side (i.e., at the fingerprint recognition device 60), respectively.

Further, as shown in FIG. 7, the diffusion sheet according to Example 5 has haze values of 33.5%, 36.7%, and 62.8% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Example 5 has visibility levels 9 and 9 when using the camera under the infrared light with the wavelength of 850 nm and the camera under the visible light (i.e., the fluorescent light), respectively.

As described above, the diffusion sheet according to Example 5 maintains certain diffusion properties of the visible light and has lower haze values with respect to the infrared light, that is, reduced diffusion properties of the infrared light. The diffusion sheet is thus applicable to fingerprint recognition.

### Example 6

As shown in FIG. 7, the diffusion sheet according to Example 6 is a base sheet having a total thickness of 276 μm and made of a matrix resin that is a UV curable resin containing titanium oxide (as fine inorganic particles). Here, the mass ratio of the fine particles to the matrix resin is 0.4%. The titanium oxide (as primary particles) has an average particle size of 0.05 μm. That is, the average particle size of the titanium oxide is ½ or less of the peak wavelengths of 850 nm and 940 nm of the infrared light source.

The diffusion sheet according to Example 6 was produced by the following method. First, ultrafine titanium oxide particles (TTO-55(S) manufactured by ISHIHARA SANGYO KAISHA, LTD.) were mixed into the UV curable resin at the mass ratio described above to prepare a titanium oxide mixed resin liquid. The UV curable resin has the same refractive index (n=1.589) as polycarbonate with respect to visible light. The mixed resin liquid was stretched into a sheet using a gap with a height of 300 μm, which was irradiated with UV light and cured to be the base sheet.

As shown in FIG. 7, the diffusion sheet according to Example 6 has roughnesses (Ra) of 0.211 μm and 0.254 μm on the visible side (i.e., at the liquid crystal display panel 5) and the back side (i.e., at the fingerprint recognition device 60), respectively.

Further, as shown in FIG. 7, the diffusion sheet according to Example 6 has haze values of 51.9%, 55.7%, and 82.3% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Example 6 has visibility levels 8 and 7 when using the camera under the infrared light with the wavelength of 850 nm and the camera under the visible light (i.e., the fluorescent light), respectively.

As described above, the diffusion sheet according to Example 6 maintains certain diffusion properties of the visible light and has lower haze values with respect to the infrared light, that is, reduced diffusion properties of the infrared light. The diffusion sheet is thus applicable to fingerprint recognition.

### Comparative Example 5

As shown in FIG. 7, the diffusion sheet according to Comparative Example 5 is a base sheet having a total thickness of 366 μm and made of a matrix resin that is a UV curable resin containing titanium oxide (as fine inorganic particles). Here, the mass ratio of the fine particles to the matrix resin is 0.8%. The titanium oxide (as primary particles) has an average particle size of 0.05 μm.

The diffusion sheet according to Comparative Example 5 was produced by the following method. First, ultrafine titanium oxide particles (TTO-55(S) manufactured by ISHIHARA SANGYO KAISHA, LTD.) were mixed into the UV curable resin at the mass ratio described above to prepare a titanium oxide mixed resin liquid. The UV curable resin has the same refractive index (n=1.589) as polycarbonate with respect to visible light. The mixed resin liquid was stretched into a sheet using a gap with a height of 300 μm, which was irradiated with UV light and cured to be the base sheet.

As shown in FIG. 7, the diffusion sheet according to Comparative Example 5 has roughnesses (Ra) of 0.324 μm and 0.332 μm on the visible side (i.e., at the liquid crystal display panel 5) and the back side (i.e., at the fingerprint recognition device 60), respectively.

Further, as shown in FIG. 7, the diffusion sheet according to Comparative Example 5 has haze values of 79.4%, 82.3%, and 97.3% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Comparative Example 5 has visibility levels 5 and 2 when using the camera under the infrared light with the wavelength of 850 nm and the camera under the visible light (i.e., the fluorescent light), respectively.

As described above, the diffusion sheet according to Comparative Example 5 has excellent diffusion properties of the visible light but higher haze values with respect to the infrared light, that is, fails to reduce the diffusion properties of the infrared light. It is thus difficult to apply the diffusion sheet to fingerprint recognition.

### Comparative Example 6

As shown in FIG. 7, the diffusion sheet according to Comparative Example 6 is a base sheet having a total thickness of 47 μm and made of a matrix resin that is polycarbonate (hereinafter, referred to as PC) containing silicone (as fine organic particles). Here, the mass ratio of the fine particles to the matrix resin is 0.8%. The silicone (as primary particles) has an average particle size of 2 μm.

The diffusion sheet according to Comparative Example 6 was produced by the following method. First, the matrix resin (i.e., the base resin) and the fine organic particles (i.e., the diffusing resin) were mixed at the mass ratio described above and subjected to extrusion molding to be a film. After that, the film was sandwiched and pressed between two metal mirror rolls into a single-layer base sheet with two mirror surfaces.

As shown in FIG. 7, the diffusion sheet according to Comparative Example 6 has roughnesses (Ra) of 0.18 μm and 0.063 μm on the visible side (i.e., at the liquid crystal display panel 5) and the back side (i.e., at the fingerprint recognition device 60), respectively.

Further, as shown in FIG. 7, the diffusion sheet according to Comparative Example 6 has haze values of 31.3%, 33.9%, and 42.5% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Comparative Example 6 has visibility levels 9 and 10 when using the camera under the infrared light with the wavelength of 850 nm and the camera under the visible light (i.e., the fluorescent light), respectively.

As described above, the diffusion sheet according to Comparative Example 6 has bad diffusion properties of the visible light. It is thus difficult to use the diffusion sheet for a liquid crystal display device.

### Comparative Example 7

As shown in FIG. 7, the diffusion sheet according to Comparative Example 7 is a base sheet having a total thickness of 44 μm and made of a matrix resin that is PC containing silicone (as fine organic particles). Here, the mass ratio of the fine particles to the matrix resin is 8%. The silicone (as primary particles) has an average particle size of 2 μm.

The diffusion sheet according to Comparative Example 7 was produced by the following method. First, the matrix resin (i.e., the base resin) and the fine organic particles (i.e., the diffusing resin) were mixed at the mass ratio described above and subjected to extrusion molding to be a film. After that, the film was sandwiched and pressed between two metal mirror rolls into a single-layer base sheet with two mirror surfaces.

As shown in FIG. 7, the diffusion sheet according to Comparative Example 7 has roughnesses (Ra) of 0.165 μm and 0.116 μm on the visible side (i.e., at the liquid crystal display panel 5) and the back side (i.e., at the fingerprint recognition device 60), respectively.

Further, as shown in FIG. 7, the diffusion sheet according to Comparative Example 7 has haze values of 94.1%, 93.6%, and 96.1% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Comparative Example 7 has visibility levels 3 and 4 when using the camera under the infrared light with the wavelength of 850 nm and the camera under the visible light (i.e., the fluorescent light), respectively.

As described above, the diffusion sheet according to Comparative Example 7 has excellent diffusion properties of the visible light but higher haze values with respect to the infrared light, that is, fails to reduce the diffusion properties of the infrared light. It is thus difficult to apply the diffusion sheet to fingerprint recognition.

### Example 7

As shown in FIG. 7, the diffusion sheet according to Example 7 is a base sheet having a total thickness of 106 μm and made of a matrix resin that is PC containing silicone (as fine organic particles). Here, the mass ratio of the fine particles to the matrix resin is 0.8%. The silicone (as primary particles) has an average particle size of 2 μm.

The diffusion sheet according to Example 7 was produced by the following method. First, the matrix resin (i.e., the base resin) and the fine organic particles (i.e., the diffusing resin) were mixed at the mass ratio described above and subjected to extrusion molding to be a film. After that, the film was sandwiched and pressed between two metal mirror rolls into a single-layer base sheet with two mirror surfaces.

As shown in FIG. 7, the diffusion sheet according to Example 7 has roughnesses (Ra) of 0.268 μm and 0.038 μm on the visible side (i.e., at the liquid crystal display panel 5) and the back side (i.e., at the fingerprint recognition device 60), respectively.

Further, as shown in FIG. 7, the diffusion sheet according to Example 7 has haze values of 48.3%, 50.7%, and 61.2% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Example 7 has visibility levels 7 and 9 when using the camera under the infrared light with the wavelength of 850 nm and the camera under the visible light (i.e., the fluorescent light), respectively.

As described above, the diffusion sheet according to Example 7 maintains certain diffusion properties of the visible light and has lower haze values with respect to the infrared light, that is, reduced diffusion properties of the infrared light. The diffusion sheet is thus applicable to fingerprint recognition.

### Example 8

As shown in FIG. 7, the diffusion sheet according to Example 8 is a base sheet having a total thickness of 111 μm and made of a matrix resin that is PC containing silicone (as fine organic particles). Here, the mass ratio of the fine particles to the matrix resin is 0.8%. The silicone (as primary particles) has an average particle size of 2 μm.

The diffusion sheet according to Example 8 was produced by the following method. First, the matrix resin (i.e., the base resin) and the fine organic particles (i.e., the diffusing resin) were mixed at the mass ratio described above and subjected to extrusion molding to be a film. After that, the film was sandwiched and pressed between two metal rolls, one of which had a random matte surface and the other had a mirror surface, into a single-layer base sheet with a random matte surface on one side and a mirror surface on the other.

As shown in FIG. 7, the diffusion sheet according to Example 8 has roughnesses (Ra) of 3.584 μm and 0.609 μm on the visible side (i.e., at the liquid crystal display panel 5) and the back side (i.e., at the fingerprint recognition device 60), respectively. That is, the visible surface has the random matte pattern.

Further, as shown in FIG. 7, the diffusion sheet according to Example 8 has haze values of 70.2%, 70.8%, and 75.2% with respect to the infrared light with the wavelength of 940 nm, the infrared light with the wavelength of 850 nm, and the visible light with the wavelength of 550 nm, respectively.

As shown in FIGS. 7 and 10, the diffusion sheet according to Example 8 has visibility levels 7 and 7 when using the camera under the infrared light with the wavelength of 850 nm and the camera under the visible light (i.e., the fluorescent light), respectively.

As described above, the diffusion sheet according to Example 8 maintains certain diffusion properties of the visible light and has lower haze values with respect to the infrared light, that is, reduced diffusion properties of the infrared light. The diffusion sheet is thus applicable to fingerprint recognition.

### Evaluation on Examples 1 to 8 and Comparative Examples 1 to 7

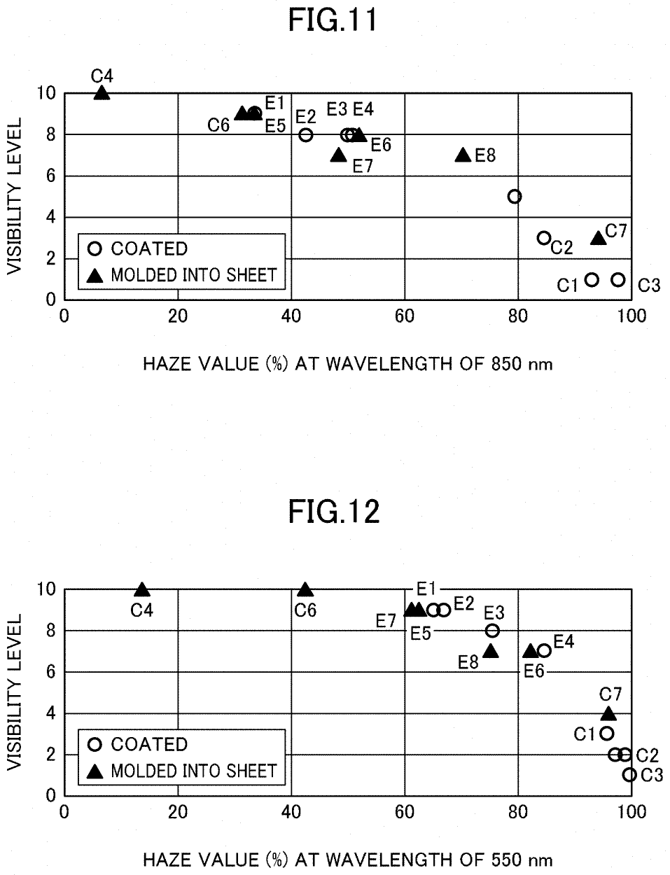

FIG. 11 shows the relationship between the haze values and visibilities of the diffusion sheets according to Examples 1 to 8 and Comparative Examples 1 to 7 with respect to infrared light. FIG. 12 shows the relationship between the haze values and visibilities of the diffusion sheets according to Examples 1 to 8 and Comparative Examples 1 to 7 with respect to visible light. In FIGS. 11 and 12, E1 to E8 represent Examples 1 to 8, whereas C1 to C7 represent Comparative Examples 1 to 7.

As shown in FIG. 11, a haze value of 75% or less with respect to the infrared light results in a visibility level of 7 or higher with respect to the infrared light, that is, reduced diffusion properties of the infrared light. With a decrease in the haze value with respect to the infrared light, the visibility level with respect to the infrared light increases, in other words, the diffusion properties of the infrared light decrease. The haze value with respect to the infrared light is more preferably 70% or less, furthermore preferably 60% or less, and still more preferably 50% or less. In particular, a haze value of 40% or less results in a visibility level of 9 or higher with respect to the infrared light, that is, largely reduced diffusion properties of the infrared light.

On the other hand, as shown in FIG. 12, a haze value of 60% or more with respect to the visible light results in a visibility level of 9 or lower with respect to the visible light to cause the diffusion properties of the visible light. With an increase in the haze value with respect to the visible light, the visibility level with respect to the visible light decreases, in other words, the diffusion properties of the visible light improve. The haze value with respect to the visible light is more preferably 65% or more, furthermore preferably 70% or more, and still more preferably 75% or more. In particular, a haze value of 80% or more results in a visibility level of 7 or lower with respect to the visible light, that is, largely improved diffusion properties of the visible light.

While the embodiment of the present disclosure (including Examples. The same applies to the following) has been thus described above, the present disclosure is not limited to the embodiment described above, and various changes and modifications may be made within the scope of the present disclosure. That is, the description of the embodiment is a mere example in nature and is not intended to limit the scope, applications, or use of the present disclosure.

For example, in the embodiment described above, the diffusion sheet with a controlled haze value according to the present disclosure is applied to the entire diffusion sheet 20 or 20A of the backlight unit 40. Instead, the diffusion sheet with a controlled haze value according to the present disclosure may be applied to only the region of the diffusion sheet corresponding to the location of the infrared detector 62 constituting the fingerprint recognition device 60, in other words, the region of the diffusion sheet corresponding to the location of the finger pulp on the liquid crystal display panel 5.

Needless to mention, the backlight unit and the liquid crystal display device to which the diffusion sheet with a controlled haze value according to the present disclosure is applied are not limited to the (side) backlight unit 40 in FIG. 3 and the liquid crystal display device 50 in FIG. 1, respectively. For example, the diffusion sheet with a controlled haze according to the present disclosure may be applied to a direct backlight unit. In this case, a light source for fingerprint recognition may be located between the backlight sources.

The present disclosure is useful for a diffusion sheet for a liquid crystal display device capable of fingerprint recognition on a liquid crystal display panel.

1. A diffusion sheet used in a liquid crystal display device in which when a finger pulp is put on a designated spot of a liquid crystal display panel, information obtained based on a fingerprint on the finger pulp is read using an infrared light source, wherein
the diffusion sheet has a haze value of 60% or more with respect to visible light, and
the diffusion sheet has a haze value of 75% or less with respect to infrared light.

2. The diffusion sheet of claim 1, comprising:
a matrix resin; and
particles contained in the matrix resin and made of at least one of an organic or inorganic substance.

3. The diffusion sheet of claim 2, wherein:
the matrix resin is an acrylic resin or a polycarbonate resin; and
the particles are made of titanium oxide.

4. The diffusion sheet of claim 2, wherein the particles have an average particle size of ½ or less of a peak wavelength of the infrared light source.

5. The diffusion sheet of claim 1, wherein the infrared light source has a peak wavelength within a near-infrared spectrum.

6. A backlight unit included in a liquid crystal display device in which when a finger pulp is put on a designated spot of a liquid crystal display panel, information obtained based on a fingerprint on the finger pulp is read using an infrared light source, and guiding light emitted from a light source with a peak wavelength within a visible spectrum to a display surface of the liquid crystal display device, the backlight unit comprising:
the diffusion sheet of claim 1.

7. A liquid crystal display device, comprising:
the backlight unit of claim 6; and
a liquid crystal display panel.

8. Information equipment, comprising the liquid crystal display device of claim 7.
